(19) United States
(12) Patent Application Publication
(10) Pub. No.: US 2022/0180340 A1
(43) Pub. Date: Jun. 9, 2022

(54) METHOD, INFORMATION PROCESSING APPARATUS, AND NON-TRANSITORY COMPUTER READABLE MEDIUM

(71) Applicant: TOYOTA JIDOSHA KABUSHIKI KAISHA, Toyota-shi (JP)

(72) Inventors: Toyokazu NAKASHIMA, Nagoya-shi (JP); Shunsuke SAGARA, Nisshin-shi (JP); Naoya OKA, Nagakute-shi (JP)

(73) Assignee: TOYOTA JIDOSHA KABUSHIKI KAISHA, Toyota-shi (JP)

(21) Appl. No.: 17/542,625

(22) Filed: Dec. 6, 2021

(30) Foreign Application Priority Data
Dec. 9, 2020 (JP) 2020-204529

(51) Int. Cl. G06Q 20/12; G08G 1/0967

(52) U.S. Cl. CPC G06Q 20/127; G06Q 2240/00; G08G 1/0967

(57) ABSTRACT

A method to be executed by an information processing apparatus includes storing, for each parking space in a plurality of parking spaces, information indicating each vehicle or each user that is authorized to use the parking space, and warning or charging a first user of a first vehicle when the first vehicle enters or parks in a first parking space that neither the first vehicle nor the first user is authorized to use.

### CROSS-REFERENCE TO RELATED APPLICATION

This application claims priority to Japanese Patent Application No. 2020-204529, filed on Dec. 9, 2020, the entire contents of which are incorporated herein by reference.

### TECHNICAL FIELD

The present disclosure relates to a method, an information processing apparatus, and a program.

### BACKGROUND

Technology related to the use of vehicle parking spaces is known. For example, patent literature (PTL) 1 discloses that users who report a nuisance vehicle improperly parked in a monthly parking lot are awarded points that can be used as partial payment of the parking fee.

### CITATION LIST

### Patent Literature

PTL 1: JP 2017-194820 A

### SUMMARY

There is room for improvement in technology related to the use of vehicle parking spaces.

It would be helpful to improve technology related to the use of vehicle parking spaces.

A method according to an embodiment of the present disclosure is a method to be executed by an information processing apparatus, the method including:

storing, for each parking space in a plurality of parking spaces, information indicating each vehicle or each user that is authorized to use the parking space; and

warning or charging a first user of a first vehicle when the first vehicle enters or parks in a first parking space that neither the first vehicle nor the first user is authorized to use.

An information processing apparatus according to an embodiment of the present disclosure is an information processing apparatus including a memory and a controller configured to:

store, for each parking space in a plurality of parking spaces, information in the memory indicating each vehicle or each user that is authorized to use the parking space; and

warn or charge a first user of a first vehicle when the first vehicle enters or parks in a first parking space that neither the first vehicle nor the first user is authorized to use.

A non-transitory computer readable medium according to an embodiment of the present disclosure stores a program configured to cause a computer to execute operations, the operations including:

storing, for each parking space in a plurality of parking spaces, information indicating each vehicle or each user that is authorized to use the parking space; and

warning or charging a first user of a first vehicle when the first vehicle enters or parks in a first parking space that neither the first vehicle nor the first user is authorized to use.

According to an embodiment of the present disclosure, technology related to the use of vehicle parking spaces is improved.

### BRIEF DESCRIPTION OF THE DRAWINGS

In the accompanying drawings:

FIG. 1 is a block diagram illustrating a schematic configuration of a system according to an embodiment of the present disclosure;

FIG. 2 is a block diagram illustrating a schematic configuration of a vehicle;

FIG. 3 is a block diagram illustrating a schematic configuration of an information processing apparatus;

FIG. 4 is a diagram illustrating an example of information regarding parking spaces; and

FIG. 5 is a flowchart illustrating operations of the information processing apparatus.

### DETAILED DESCRIPTION

Hereinafter, an embodiment of the present disclosure will be described.

### Summary of Embodiment

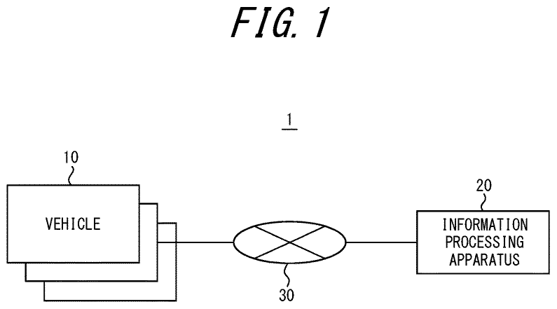

An outline of a system 1 according to an embodiment of the present disclosure will be described with reference to FIG. 1. The system 1 includes a vehicle 10 and an information processing apparatus 20. The vehicle 10 and the information processing apparatus 20 are communicably connected to a network 30 including, for example, the Internet, a mobile communication network, or the like.

The vehicle 10 is an automobile, for example, but is not limited to this, and may be any appropriate vehicle. The vehicle 10 may be driven by a driver. The vehicle 10 may be capable of automated driving such as any one of Level 1 to Level 5 as defined by the Society of Automotive Engineers (SAE), for example. The number of vehicles 10 provided in the system 1 may be freely determined. A user of the vehicle 10 may be a driver who boards the vehicle 10 or remotely performs driving operations, or may be an occupant or passenger of the vehicle 10. The user of the vehicle 10 may be the owner of the vehicle 10 or a borrower of the vehicle 10.

The information processing apparatus 20 is, for example, a server apparatus but is not limited to this and may be any appropriate computer. The information processing apparatus 20 can communicate with the vehicle 10 via the network 30.

First, an outline of the present embodiment will be described, and details thereof will be described later. The information processing apparatus 20 stores, for each parking space among a plurality of parking spaces, information indicating each vehicle 10 or each user that is authorized to use the parking space. When a certain vehicle (hereinafter also referred to as the “first vehicle 10”) enters or parks in a first parking space that neither the first vehicle 10 nor the user of the first vehicle 10 (hereinafter also referred to as the “first user”) is authorized to use, the information processing apparatus 20 warns or charges the first user.

According to the present embodiment, when the first vehicle 10 enters or parks in the first parking space while neither the first vehicle 10 nor the first user is authorized to use the first parking space, the first user is thus warned or charged. This improves technology related to the use of parking spaces for the vehicle 10 in that the probability of improper entry or parking by the first vehicle 10 in the first parking space can be reduced.

Next, configurations of the system 1 will be described in detail.

(Configuration of Vehicle)

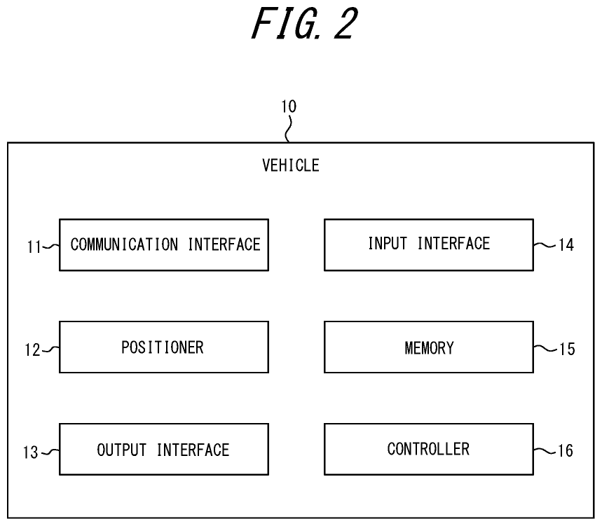

As illustrated in FIG. 2, the vehicle 10 includes a communication interface 11, a positioner 12, an output interface 13, an input interface 14, a memory 15, and a controller 16.

The communication interface 11 includes at least one communication interface for connecting to the network 30. The communication interface is compliant with mobile communication standards such as the 4th generation (4G) standard or the 5th generation (5G) standard, for example, but these examples are not limiting. In the present embodiment, the vehicle 10 communicates with the information processing apparatus 20 via the communication interface 11 and the network 30.

The positioner 12 includes one or more apparatuses configured to acquire positional information for the vehicle 10. Specifically, the positioner 12 includes, for example, a receiver compliant with GPS, but is not limited to this example and may include a receiver compliant with any appropriate satellite positioning system.

The output interface 13 includes at least one output device for outputting information to notify the user of the information. The output device is a display for outputting information as video, a speaker for outputting information as audio, or the like, for example, but is not limited to these. The display may be a panel display that outputs image as real images, or a head-up display that displays images as virtual images.

The input interface 14 includes at least one input device for detecting user input. The input device is a physical key, a capacitive key, a touchscreen integrally provided with a display of the output interface 13, a microphone for accepting audio input, a camera, or the like, for example, but is not limited to these.

The memory 15 includes one or more memories. The memories are semiconductor memories, magnetic memories, optical memories, or the like, for example, but are not limited to these. The memories included in the memory 15 may each function as, for example, a main memory, an auxiliary memory, or a cache memory. The memory 15 stores any information used for operations of the vehicle 10. For example, the memory 15 may store a system program, an application program, embedded software, and the like. The information stored in the memory 15 may be updated with, for example, information acquired from the network 30 via the communication interface 11.

The controller 16 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 16 controls the operations of the entire vehicle 10.

(Configuration of Information Processing Apparatus)

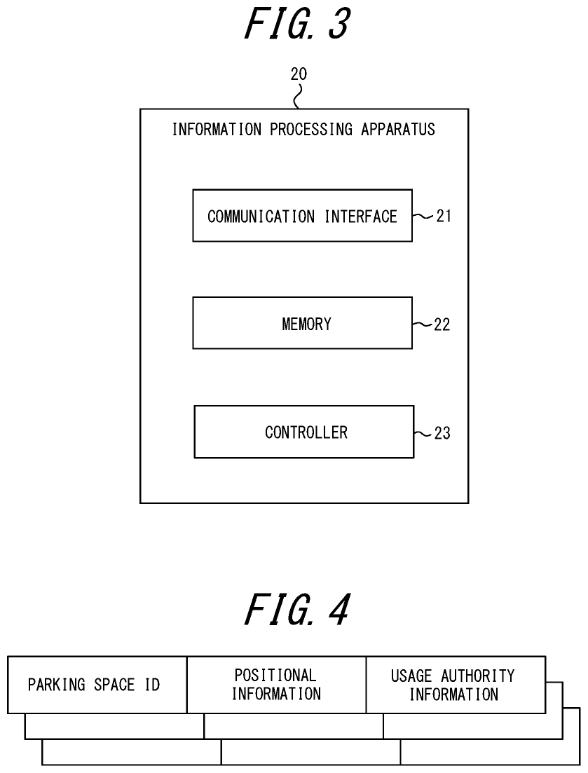

As illustrated in FIG. 3, the information processing apparatus 20 includes a communication interface 21, a memory 22, and a controller 23.

The communication interface 21 includes at least one communication interface for connecting to the network 30. The communication interface may be compliant with, for example, mobile communication standards, wired local area network (LAN) standards, or wireless LAN standards, but these examples are not limiting. The communication interface may be compliant with any appropriate communication standards. In the present embodiment, the information processing apparatus 20 communicates with the vehicle 10 via the communication interface 21 and the network 30.

The memory 22 includes one or more memories. The memories included in the memory 22 may each function as, for example, a main memory, an auxiliary memory, or a cache memory. The memory 22 stores any information used in operation of the information processing apparatus 20. For example, the memory 22 may store a system program, an application program, a database, map information, and the like. The information stored in the memory 22 may be updated with, for example, information acquired from the network 30 via the communication interface 21.

In the present embodiment, the memory 22 stores information regarding parking spaces. The information regarding parking spaces includes, for each parking space in a plurality of parking spaces, information indicating each vehicle 10 or each user that is authorized to use the parking space. For example, as illustrated in FIG. 4, the information regarding a parking space may include a “parking space ID,” “positional information,” and “usage authority information” for each parking space.

The “parking space ID” is information that uniquely identifies a parking space. The “positional information” is information indicating the position of the parking space. The “usage authority information” is information that uniquely identifies each vehicle 10 or each user that is authorized to use the parking space.

The controller 23 includes at least one processor, at least one programmable circuit, at least one dedicated circuit, or a combination of these. The controller 23 controls operations of the entire information processing apparatus 20.

(Operation Flow in Information Processing Apparatus)

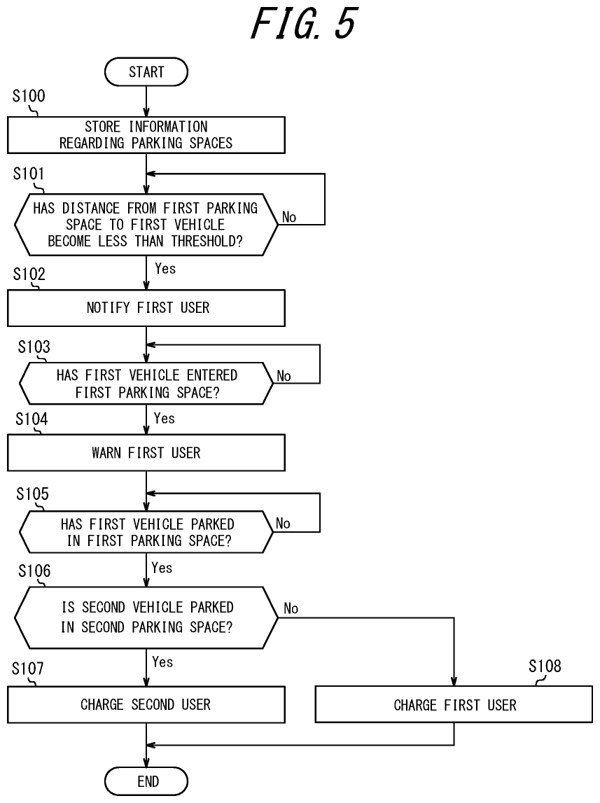

Operations of the information processing apparatus 20 according to the present embodiment will be described with reference to FIG. 5.

Step S100: the controller 23 of the information processing apparatus 20 stores, for each parking space, information indicating each vehicle or each user that is authorized to use the parking space.

Specifically, the controller 23 may, for example, store the above-described information regarding parking spaces in the memory 22. In the present embodiment, neither a first vehicle 10 nor a first user, who is the user of the first vehicle 10, is authorized to use the first parking space. On the other hand, the first vehicle 10 and/or the first user is authorized to use a second parking space. Neither a second vehicle 10 nor a second user of the second vehicle 10 is authorized to use the second parking space. In the present embodiment, the first parking space and the second parking space are located within a predetermined area, such as a single parking lot.

Step S101: the controller 23 judges whether the distance from the first parking space to the first vehicle 10 has become less than a predetermined threshold. When it is judged that the distance has become less than the threshold (step S101: Yes), the process advances to step S102. Conversely, when it is judged that the distance has not become less than the threshold (step S101: No), the process repeats step S101.

Specifically, the controller 23 receives positional information for the first vehicle 10 from the first vehicle 10 via the communication interface 21. The controller 23 calculates the distance from the first parking space to the first vehicle 10 based on the positional information for the first vehicle 10 and the positional information for the first parking space. The controller 23 then judges whether the calculated distance has become less than a predetermined threshold.

Step S102: when it is judged in step S101 that the distance from the first parking space to the first vehicle 10 has become less than the predetermined threshold (step S101: Yes), the controller 23 notifies the first user that neither the first vehicle 10 nor the first user is authorized to use the first parking space.

When the first user is thus notified about not being authorized to use the first parking space, the first user can recognize that the first vehicle 10 should not use the first parking space. Accordingly, the probability that the first vehicle 10, after approaching the first parking space, will improperly enter or park in the first parking space can be reduced.

Any method can be used to notify the user of the vehicle 10 of the information. For example, the memory 22 may store, in advance, data on an email address or a user account for each user. In this case, the controller 23 may notify any user of the information by transmitting the information to the email address or user account for the user. For example, the memory 22 may store, in advance, data on the terminal apparatus or vehicle 10 used by each user. In this case, the controller 23 may notify any user of the information by transmitting the information to the terminal apparatus or vehicle 10 of the user. For example, the controller 23 can also notify the user of the vehicle 10 that has approached the first parking space of the information by outputting the information via a display, a speaker, or the like provided near the first parking space.

Step S103: the controller 23 judges whether the first vehicle 10 has entered the first parking space. When it is judged that the first vehicle 10 has entered the first parking space (step S103: Yes), the process advances to step S104. Conversely, when it is judged that the first vehicle 10 has not entered the first parking space (step S103: No), the process repeats step S103.

Here, any method can be used to judge whether the vehicle 10 has entered the parking space. For example, the controller 23 may judge that the vehicle 10 has entered the parking space when the positional information for the vehicle 10, which changes over time, substantially matches the positional information for the parking space. As another example, the controller 23 may receive, via the communication interface 21, images of the parking space from an in-vehicle camera, such as a drive recorder mounted in the vehicle 10, a monitoring camera installed near the parking space, or the like. In this case, the controller 23 judges whether the vehicle 10 has entered the parking space by implementing predetermined image processing, such as image recognition, using the received image.

Step S104: when it is judged in step S103 that the first vehicle 10 has entered the first parking space (step S103: Yes), the controller 23 warns the first user.

Specifically, the controller 23 notifies the first user of predetermined warning information. The warning information includes, for example, a message warning that the first user may be charged if the first vehicle 10 parks in the first parking space. However, the content of the warning information is not limited to this example and may be freely defined.

Step S105: the controller 23 judges whether the first vehicle 10 has parked in the first parking space. When it is judged that the first vehicle 10 has parked in the first parking space (step S105: Yes), the process advances to step S106. Conversely, when it is judged that the first vehicle 10 has not parked in the first parking space (step S105: No), the process repeats step S105.

Here, any method can be used to judge whether the vehicle 10 has parked in the parking space. For example, the controller 23 may judge that the vehicle 10 has parked in the parking space when the positional information for the vehicle 10 and the positional information for the parking space continue to substantially match for a predetermined length of time. As another example, the controller 23 may determine that the vehicle 10 has parked in the parking space when information indicating that the vehicle 10 has parked is received from the vehicle 10 via the communication interface 21 while the positional information for the vehicle 10 and the positional information for the parking space substantially match.

Step S106: when it is judged in step S105 that the first vehicle 10 has parked in the first parking space (step S105: Yes), the controller 23 determines whether the second vehicle 10 is parked in the second parking space. When it is judged that the second vehicle 10 is parked in the second parking space (step S106: Yes), the process advances to step S107. Conversely, when it is judged that the second vehicle 10 is not parked in the second parking space (step S106: No), the process advances to step S108.

As described above, neither the second vehicle 10 nor the second user is authorized to use the second parking space. Accordingly, in step S106, it is judged whether the second vehicle 10 is improperly parked in the second parking space.

Step S107: when it is judged in step S106 that the second vehicle 10 is parked in the second parking space (step S106: Yes), the controller 23 charges the second user. The process then ends.

Here, any method can be used to charge users. For example, the memory 22 may store payment information for each user in advance. The payment information may include bank account information, credit card information, or the like, but is not limited to these examples. The controller 23 may request that a server of a bank, a credit card company, or the like perform a billing process for the user based on the user's payment information.

As described above, the first vehicle 10 and/or the first user is authorized to use the second parking space. Therefore, in step S107, the first vehicle 10 might have been forced to park in the first parking space due to the particular circumstances of the second vehicle 10 being improperly parked in the second parking space. Therefore, in step S107, the second user is charged instead of the first user.

Step S108: when it is judged in step S106 that the second vehicle 10 is not parked in the second parking space (step S106: No), the controller 23 charges the first user. The process then ends.

Here, the controller 23 may charge the first user when the first user gets out of the first vehicle 10 parked in the first parking space.

As described above, the information processing apparatus 20 of the present embodiment stores, for each parking space, information indicating each vehicle 10 or each user that is authorized to use the parking space. When the first vehicle 10 enters or parks in the first parking space that neither the first vehicle 10 nor the first user is authorized to use, the information processing apparatus 20 warns or charges the first user.

According to this configuration, when the first vehicle 10 enters or parks in the first parking space while neither the first vehicle 10 nor the first user is authorized to use the first parking space, the first user is thus warned or charged. This improves technology related to the use of parking spaces for the vehicle 10 in that the probability of improper entry or parking by the first vehicle 10 in the first parking space can be reduced.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, an embodiment in which the configuration and operations of the information processing apparatus 20 in the above embodiment are distributed to a plurality of computers capable of communicating with each other can also be implemented. For example, an embodiment in which some or all of the components of the information processing apparatus 20 are provided in the vehicle 10 can also be implemented. For example, a navigation apparatus mounted in the vehicle 10 may be equipped with some or all of the components of the information processing apparatus 20.

For example, in the example described in the above embodiment, the first user is warned when the first vehicle 10 enters the first parking space, and the first user can then be charged upon the first vehicle 10 parking in the first parking space. However, the first user may be charged upon the first vehicle 10 parking in the first parking space, for example, or the first user may be warned when the first vehicle 10 parks in the first parking space.

For example, an embodiment in which a general purpose computer functions as the information processing apparatus 20 according to the above embodiment can also be implemented. Specifically, a program in which processes for realizing the functions of the information processing apparatus 20 according to the above embodiment are written may be stored in a memory of a general purpose computer, and the program may be read and executed by a processor. Accordingly, the present disclosure can also be implemented as a program executable by a processor, or a non-transitory computer readable medium storing the program.

1. A method to be executed by an information processing apparatus, the method comprising:
storing, for each parking space in a plurality of parking spaces, information indicating each vehicle or each user that is authorized to use the parking space; and
warning or charging a first user of a first vehicle when the first vehicle enters or parks in a first parking space that neither the first vehicle nor the first user is authorized to use.

2. The method of claim 1, wherein the warning or charging comprises warning, by the information processing apparatus, the first user when the first vehicle enters the first parking space.

3. The method of claim 1, wherein the warning or charging comprises charging, by the information processing apparatus, the first user when the first vehicle parks in the first parking space and the first user gets out from the first vehicle parked in the first parking space.

4. The method of claim 1, further comprising notifying the first user, when a distance from the first parking space to the first vehicle becomes less than a threshold, that neither the first vehicle nor the first user is authorized to use the first parking space.

5. The method of claim 1, wherein the warning or charging comprises not charging, by the information processing apparatus, the first user when the first vehicle enters or parks in the first parking space while a second vehicle is parked in a second parking space that the first vehicle or the first user is authorized to use.

6. The method of claim 5, wherein the second vehicle and a second user of the second vehicle are a vehicle and a user that are not authorized to use the second parking space.

7. The method of claim 6, further comprising charging the second user when the first vehicle parks in the first parking space while the second vehicle is parked in the second parking space.

8. An information processing apparatus comprising a memory and a controller configured to:
store, for each parking space in a plurality of parking spaces, information in the memory indicating each vehicle or each user that is authorized to use the parking space; and
warn or charge a first user of a first vehicle when the first vehicle enters or parks in a first parking space that neither the first vehicle nor the first user is authorized to use.

9. The information processing apparatus of claim 8, wherein the controller is configured to warn the first user when the first vehicle enters the first parking space.

10. The information processing apparatus of claim 8, wherein the controller is configured to charge the first user when the first vehicle parks in the first parking space and the first user gets out from the first vehicle parked in the first parking space.

11. The information processing apparatus of claim 8, wherein the controller is configured to notify the first user, when a distance from the first parking space to the first vehicle becomes less than a threshold, that neither the first vehicle nor the first user is authorized to use the first parking space.

12. The information processing apparatus of claim 8, wherein the controller is configured not to charge the first user when the first vehicle enters or parks in the first parking space while a second vehicle is parked in a second parking space that the first vehicle or the first user is authorized to use.

13. The information processing apparatus of claim 12, wherein the second vehicle and a second user of the second vehicle are a vehicle and a user that are not authorized to use the second parking space.

14. The information processing apparatus of claim 13, wherein the controller is configured to charge the second user when the first vehicle parks in the first parking space while the second vehicle is parked in the second parking space.

15. A non-transitory computer readable medium storing a program configured to cause a computer to execute operations, the operations comprising:
storing, for each parking space in a plurality of parking spaces, information indicating each vehicle or each user that is authorized to use the parking space; and
warning or charging a first user of a first vehicle when the first vehicle enters or parks in a first parking space that neither the first vehicle nor the first user is authorized to use.

16. The medium of claim 15, wherein the computer is configured to warn the first user when the first vehicle enters the first parking space.

17. The medium of claim 15, wherein the computer is configured to charge the first user when the first vehicle parks in the first parking space and the first user gets out from the first vehicle parked in the first parking space.

18. The medium of claim 15, wherein the program is configured to cause the computer to execute the operations further comprising notifying the first user, when a distance from the first parking space to the first vehicle becomes less than a threshold, that neither the first vehicle nor the first user is authorized to use the first parking space.

19. The medium of claim 15, wherein the computer is configured not to charge the first user when the first vehicle enters or parks in the first parking space while a second vehicle is parked in a second parking space that the first vehicle or the first user is authorized to use.

20. The medium of claim 19, wherein
the second vehicle and a second user of the second vehicle are a vehicle and a user that are not authorized to use the second parking space, and
the program is configured to cause the computer to execute the operations further comprising charging the second user when the first vehicle parks in the first parking space while the second vehicle is parked in the second parking space.
